(19) United States
(12) Patent Application Publication
(10) Pub. No.: US 2004/0015369 A1
(43) Pub. Date: Jan. 22, 2004

(54) Workflow system for managing versions of a document, and method for managing versions of a document using the same

(76) Inventors: Yeong-Ho Kim, Gyeonggi-do (KR); Hye-Rim Bea, Seoul (KR); Hwan-Cheol Lim, Daejeon (KR); Ho-Seong Song, Gyeonggi-do (KR); Byeong-Kwon Kwak, Incheon (KR)

Correspondence Address: BAKER BOTTS L.L.P., 2001 ROSS AVENUE, SUITE 600, DALLAS, TX, 75201-2980, US

(21) Appl. No.: 10/398,853

(22) PCT Filed: Aug. 9, 2002
(86) PCT No.: PCT/KR02/01526

(30) Foreign Application Priority Data
Aug. 9, 2001 (KR) 2001/47961

(51) Int. Cl. G06F 17/60

(52) U.S. Cl. 705/1

(57) ABSTRACT

The present invention discloses a workflow system for managing versions of a document, which can manage a variation history of the document and minimize the stored data of the document, and a method for managing versions of a document using the same. The workflow system includes the workflow engine, which consists of a flow control module for generating a control command according to a command from a client computer or self operation, a DB storage module for storing process definition defined in the client computer and information on a document file stored in an EDMS server in a database, and a file management module for calling a function for managing the document file from the EDMS server, and the adapter module for interface between the workflow engine and the EDMS server. The EDMS database for the workflow system stores the document file by using an extensible markup language, and the workflow engine compares a before-correction document with an after-correction document, stores the corrected document file in the EDMS database by using XML tags, and generates a final document file by combining the before-correction document file and the corrected document file, thereby minimizing the data storage of the document.

### TECHNICAL FIELD

The present invention relates to a workflow system, and in particular to a workflow system for managing versions of a document, which can manage the variation history of a document and minimize the stored data of the document when the document is augmented, corrected or deleted, and a method for managing versions of a document using the same.

### BACKGROUND ART

In general, a workflow is defined as a whole or partial business process for transmitting documents, information or works from one participant to another participant according to a series of procedures or rules. A workflow system is an automatic system for collectively managing workflows.

Exemplary business processes include insurance contract service works of an insurance company, delivery service works of a delivery company and loan service works of a bank. The workflow system interprets and embodies a business process composed of relations and flows between resources relating to the daily works of an organization, so that people can work by using this business process. It is called process definition.

The insurance contract service works will now be explained in detail with reference to FIG. 1. The business process has sequential steps of client order acceptance, contract document preparation, and prepared document approval. In the insurance contract service works, the respective order acceptance, document preparation, and document approval works are unit activities of the workflow. The unit activity of the workflow is a minimum logical unit, which includes human beings, resources and information.

FIG. 2 illustrates the process for processing a document file by unit activities in a conventional workflow system to provide the insurance contract service of FIG. 1. Firstly, when a client intends to buy insurance by telephone, a visit to the company or through internet, a worker accepting the request generates a document file f1 in the order acceptance unit activity by inputting the input data, such as personal information and income of the client, to calculate an insurance bill or approve an insurance contract, and stores the document file f1 in a common database.

Thereafter, when document file f1 is transmitted to the next worker through the workflow system according to the prescribed process definition, the worker generates a document file f2 in the contract document preparation unit activity by adding various data to document file f1 to calculate the insurance bill or approve the insurance contract, and stores the document file f2 in the common database. Since document file f1 is replaced by document file f2, document file f2 is stored in the common database and the original document file f1 does not exist.

In the prepared document approval unit activity, a final insurance bill or a contract approval message is added to document file f2 to generate a document file f3. Thus, document file f3 is stored in the common database, and document file f2 does not exist.

Accordingly, the conventional workflow system cannot manage a version of the document that is generated during the unit activities processed in each business process, and thus cannot provide a variation history of the documents. It is impossible to find out which contents of the document were altered in which stage of the unit activities.

The current system for managing versions of a document is an electronic document management system (EDMS). The EDMS manages a variety of documents in a company by using a computer program and a storage device. That is, the EDMS enables the company and its workers to generate documents, convert the paper documents into electronic ones, and store, edit, output and process those documents. The EDMS can manage image, video and audio documents as well as text documents. Whenever the contents of the document are altered due to correction or addition, the EDMS generates a new version of the document, and stores the document separately from the previous document file, thereby easily managing the variation history of the document. However, the EDMS is mostly used to manage the variation history of documents, and thus not suitable to serve as a workflow system to facilitate works according to the workflow of the company.

### DISCLOSURE OF INVENTION

Accordingly, the primary object of the present invention is to provide a workflow system for managing versions of a document that can manage the variation history of a document through an efficient interface with an EDMS, and a method for managing versions of a document using the same.

Another object of the present invention is to provide a workflow system for managing versions of documents that can minimize the stored data of documents with various versions, and a method for managing versions of a document using the same.

In order to achieve the above-described objects of the invention, a workflow system is connected through a communication network to at least one client computer and an EDMS server including a database for storing document files for managing the versions of documents, and a file management module having functions for managing the files, and the workflow system includes a workflow engine, a database, and an adapter module for the interface between the workflow engine and the EDMS server, wherein the workflow engine comprises: a flow control module for generating control command according to a command from the client computer or from the workflow engine itself; a DB storage module for storing the process definition defined in the client computer, the path of the document file stored in the EDMS server, the version relations between the document files, the correction date and the corrector of the document file in the database; and a file management module controlled by the flow control module, for calling the function for managing the document file from the EDMS server.

Also provided is a method for managing versions of a document in a workflow system that is connected through a communication network to at least one client computer and an EDMS server including a database for storing document files for managing the versions of the document, and a file management module having functions for managing the files, which includes a workflow engine, a database, and an adapter module including a plurality of application program interfaces (API) for interface between the workflow engine and the EDMS server, and an adapter implementation module for calling the function for managing the files from the EDMS server, comprising: a step for storing an environment value including information on specifications of the EMDS server; a step wherein the workflow engine receives a document work command through the client computer, and calls the corresponding API from the adapter module; a step wherein the called API calls the adapter implementation module of the adapter module corresponding to the environment value; and a step wherein the adapter implementation module calls the function for performing the user's document work command from the file management module of the EDMS system, and performs the user's command.

### BRIEF DESCRIPTION OF THE DRAWINGS

The present invention will become better understood with reference to the accompanying drawings, which are given only by way of illustration and thus are not limitative of the present invention, wherein:

FIG. 1 is a view illustrating a business process of insurance contract service works;

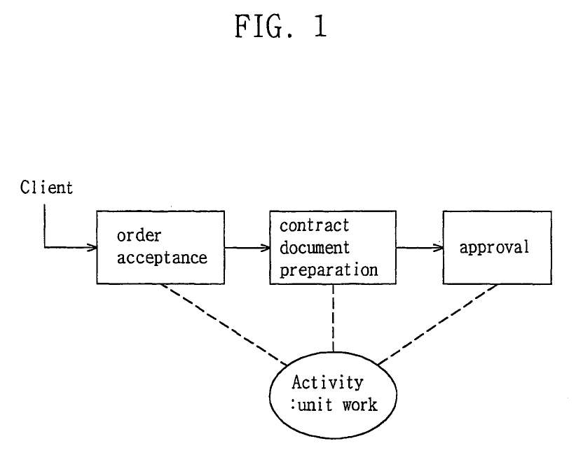

FIG. 2 is a view illustrating a process for processing a document file by the unit activities in a conventional workflow system to provide insurance contract service of FIG. 1;

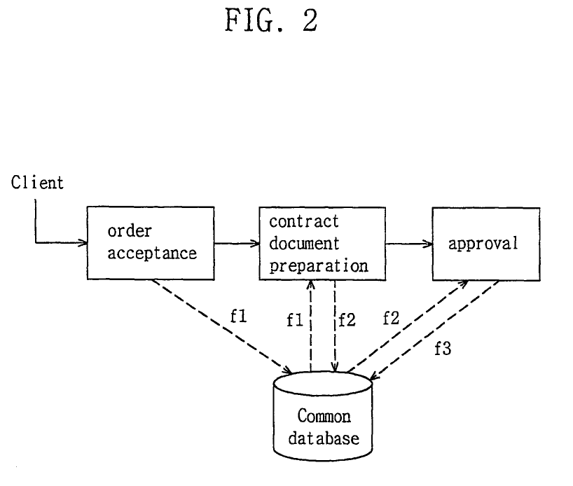

FIG. 3 is a view illustrating an application state of a workflow system in accordance with the present invention;

FIG. 4 is a detailed structure illustrating a workflow server of FIG. 3;

FIG. 5 is a detailed structure illustrating an EDMS server of FIG. 3;

FIG. 6 is a flowchart showing a method for managing versions of a document in a workflow system in accordance with the present invention;

FIG. 7 is a detailed structure illustrating a modified example of the workflow server of FIG. 4; and

FIG. 8 is a flowchart showing a process for correcting and storing a document file and generating a final document file by using an extensible markup language (XML) in the workflow system in accordance with the present invention.

### BEST MODE FOR CARRYING OUT THE INVENTION

A workflow system for managing versions of a document and a method for managing versions of a document using the same in accordance with a preferred embodiment of the present invention will now be described in detail with reference to the accompanying drawings.

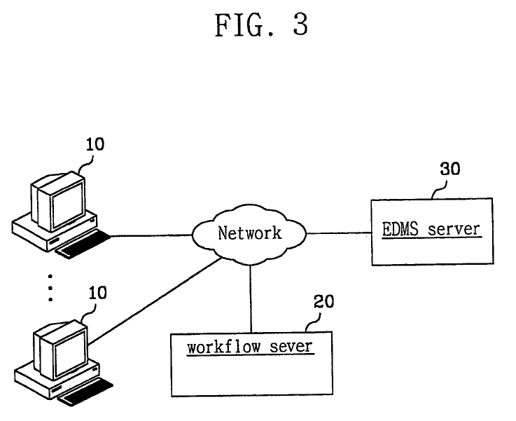

FIG. 3 is a view illustrating the application state of the workflow system in accordance with the present invention. In reference to FIG. 3, the workflow system (workflow server 20) is connected to at least one client computer 10 and an EDMS server 30. These systems can access each other through an internal local area network (LAN), a wide area network (WAN) or an internet network. In accordance with the present invention, the “internet network” implies network groups that are mutually accessible according to a standard protocol such as the TCP/IP, HTTP, and a wireless internet protocol (for example, WAP). It covers future variations including modifications or additions for the existing standard protocol.

The client computer 10 performs process definition, transmits it to workflow server 20 and stores it. In addition, the client computer 10 transmits a command for managing a document file to the EDMS server 30 through the workflow server 20.

The workflow server 20, on which a workflow engine 21 is mounted, receives a control command that includes the process definition from the client computer 10, and stores it in database 25 or controls the EDMS server 30.

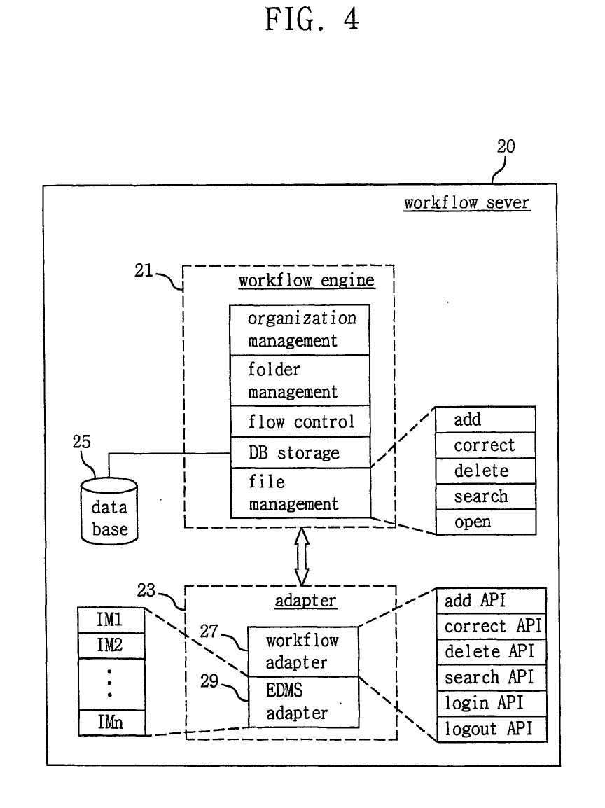

FIG. 4 is a detailed structure illustrating the workflow server 20. As depicted in FIG. 4, the workflow server 20 includes a workflow engine 21 and an adapter module 23.

The workflow engine 21 controls works based on the process definition, and receives the control command for adding, correcting, deleting or searching the document file from the client, or operates according to the workflow engine itself The workflow engine 21 includes an organization management module, a folder management module, a flow control module, a DB storage module and a file management module.

The organization management module performs ID management, and access right grant and deletion (login control) to manage people who join the workflow system.

The folder management module is used to systematically manage items on the process definition. That is, it enables the users to know which process definition exists in which folder. For example, car insurance process definition, life insurance process definition and fire insurance process definition can be stored in an insurance folder.

The flow control module serves to transmit the control command to the DB storage module or the file management module on the basis of the command from the client computer 10 or self-operation.

The DB storage module stores the process definition defined in the client computer 10, the path of the file stored in the EDMS server 30, the version relation between the document files, the correction date and the corrector of the document file in database 25.

The file management module is controlled by the flow control module, and includes functions for adding, correcting, deleting, searching and opening the document to/from the EDMS server 30. In order to perform addition, correction, deletion, search or open functions, the file management module calls a corresponding application program interface (API) from the adapter module 23.

The adapter module 23 is a program module for interface between the workflow engine 21 and the EDMS server 30. It can be linked to the existing EDMS systems. That is, although the existing EDMS systems use different document file storing methods, the adapter module 23 can be freely linked to different EDMS systems without modifying workflow engine 21.

In accordance with the present invention, when the flow control module of workflow engine 21 transmits the document management command to add, correct, delete, search or open the document file to the file management module, the file management module executes the command to/from the EMDS server 30 through the adapter.

The adapter module 23 has a module for interfacing with workflow engine 21, namely the workflow adapter 27 and a module for interfacing with the file management module of the EDMS server 30, namely the EDMS adapter module 29.

The workflow adapter 27 includes an addition API, correction API, deletion API, search API, login API, logout API and open API, and the EDMS adapter 29 includes at least one adapter implementation module IM1, IM2, . . . , IMn according to the specifications of the EDMS system.

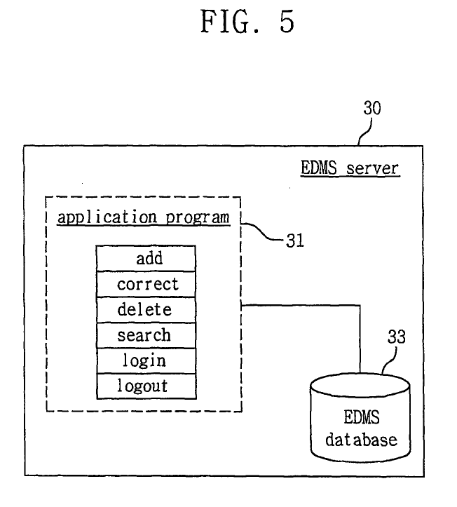

FIG. 5 is a detailed structure illustrating the EDMS server 30. As illustrated in FIG. 5, the EDMS server 30 includes application program 31 for managing document files, and EDMS database 33 for storing the document fifes. Identical to the file management module of workflow engine 21, the application program 31 has functions for adding, correcting, deleting, searching, logging in and logging out the document files, respectively. The file management module of EDMS manages the versions of the document file. When the document file is corrected, the file management module stores the original file and the corrected file in the EDMS database 33, so that the users can confirm the variation history of the file, namely who modifies which file at what time.

The addition API, correction API, deletion API, search API and open API of the workflow adapter 27 of FIG. 4 are executed by calling the addition, correction, deletion, search and open functions of the file management module of workflow engine 21. When each of the APIS is executed, the APIS reads a previously-set EDMS environment value, and calls a corresponding implementation module from the EDMS adapter 29. The “EDMS environment value” is previously set up by the client because of the different data storing methods of EDMS systems, and includes information on data storing methods, manufacturing companies and versions of EDMS systems. The flow control module of workflow engine 21 stores data of the environment value inputted by the client in a storage space of workflow server 20. Accordingly, when the user intends to add, correct, delete or search the document file to/from the EDMS database 33, the corresponding API of the workflow adapter 27 reads the environment value, and executes the corresponding adapter implementation module of EDMS adapter 29. Each of the adapter implementation modules serves to interface with the file management module of a specific EDMS system. When the adapter implementation module is performed, the file addition, correction, deletion, search or open function is called from the file management module of the EDMS system, thereby managing the files.

On the other hand, when the user logs on workflow engine 21 and the file management module of workflow engine 21 initially calls one API from workflow adapter 27, the login API is called and executed prior to the API. That is, the flow control module of the workflow engine 21 transmits a login value such as the ID and the password inputted for user approval in the organization management module to the EDMS server 30, and accesses the EDMS server 30. Thus, the system internally processes a login process to access the EDMS server 30, but the user does not recognize this system-internal login process. In the case where the user logs out of workflow engine 21, the logout API is automatically executed and logged out of the EDMS server 30.

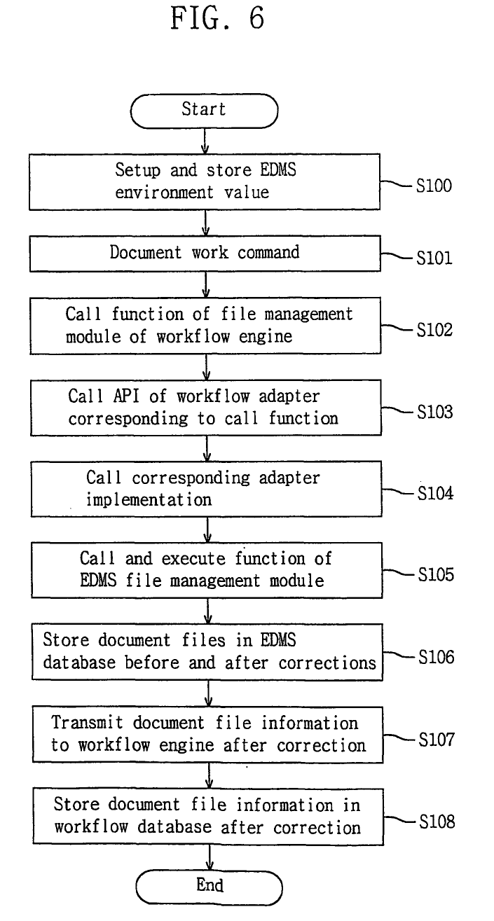

FIG. 6 is a flowchart showing a method for managing the versions of a document in the workflow system in accordance with the present invention.

The user of the workflow system must set up the environment value of the EDMS system used in the workflow system before starting the document file works (S100). The workflow engine 21 stores the environment value in the memory, so that the workflow adapter 27 can refer to this value.

Thereafter, the user gives the document work command (S101). When workflow engine 21 receives the work command through the client computer 10, it calls the function of the file management module corresponding to the command (S102). For example, the document work command relates to addition, correction, deletion, search and opening of the document file f1, and the called function of the file management module is a function corresponding to the document work.

The function called by the file management module calls the corresponding API from the workflow adapter 27 (S103). The workflow adapter 27 includes the addition API, correction API, deletion API, search API, login API, logout API and open API.

The called API calls the adapter implementation module, which corresponds to the environment value and is embodied to interface with the file management module of the specific EDMS system from EDMS adapter 29 (S104). The adapter implementation module calls the function for performing the user's document work command from the file management module of the EDMS server 30 (S105).

When the contents of the document are altered according to the user's command, the EDMS server 30 individually stores the before-correction document file f1 and the after-correction document file f2 (S106). In this case, the EDMS server 30 transmits information on the document file after the correction, namely file name, version, correction date and document capacity to workflow engine 21 (S107), and the workflow engine 21 stores the document file information in the database 25 (S108). The user can refer to the stored information in the afterward document file works, thereby easily managing the documents.

On the other hand, when the user logs on to workflow engine 21 and the file management module of workflow engine 21 initially calls one API from the workflow adapter 27, the flow control module of the workflow engine 21 calls and executes the login API before the API. Therefore, the flow control module transmits a login value such as the ID and the password inputted for user approval in the operation management module to the EDMS system and accesses the EDMS system. In the same manner, when the user logs out of workflow engine 21, the flow control module of the workflow engine 21 automatically executes the logout API to automatically log out of the EDMS system.

When the contents of the document are altered according to the user's command, the EDMS server 30 stores the before-correction document file f1 and the after-correction document file f2 as different files. Even if only a small part of the document file f1 is corrected, the corrected and uncorrected parts of the document file f1 are combined and stored as a new document file f2, thereby occupying a large capacity of the EDMS database 33 and increasing the system maintenance expenses.

In order to solve the foregoing problem, the present invention suggests a method and a system for minimizing the data by comparing the before-correction document with the after-correction document in the correction of the document file, and storing only the corrected part of the data with a markup language. Representative markup languages include hypertext markup language (HTML) and extensible markup language (XML). In the preferred embodiment of the invention, data are stored by using XML, which is not intended to be limiting. The document file stored in XML type may be a document file which has been prepared in XML type, or a document file which has not been prepared in XML type such as a Microsoft word (extension DOC) or Hangul Wordian (extension HWP) file.

The XML overcomes the limitations of HTML, which has been used in the internet, and reduces the complications of SGML. It has an additional function for enabling the user to define a new tag.

In the principle of the present invention, the document file f1 is stored by using XML. When document file f1 is corrected, the document file f1 is compared with the corrected document file f2, and the corrected file Δf1 with only the corrections is stored by using XML, instead of storing document file f2.

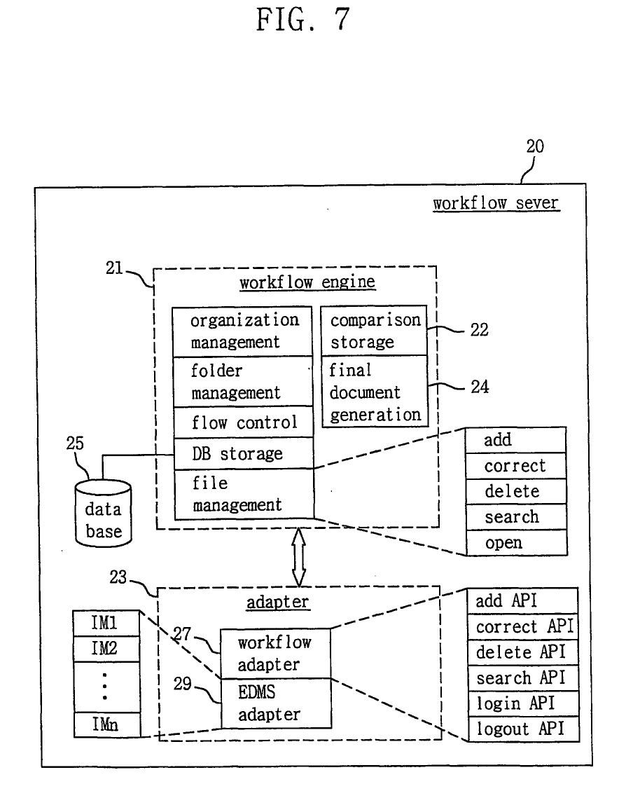

For this, the workflow engine 21 of FIG. 4 must be modified. FIG. 7 is a detailed structure illustrating a modified example of the workflow server 20 including the workflow engine 21. In reference to FIG. 7, as compared with workflow server 20 of FIG. 4, workflow engine 21 includes a comparison storage module 22 for comparing the original document file f1 with the corrected document file f2, searching the corrected document part, adding the searched document part between an XML tag pair, and storing the corrected document file Δf1 in the EDMS database 33, and a final document generation module 24 for generating a final document file by combining the document file f1 and the corrected document file Δf1. The comparison storage module 22 and the final document generation module 24 can be mounted on the client computer 10. Such modifications are easily understood by those skilled in this art.

For example, the document file f1 formed by using XML and stored in EDMS database 33 and the document file f2 formed by correcting “Kim sooni” into “Kim sookhee” in the document file f1 are suggested as follows:

Document file f1

<?xml version=“1.0” encoding=“euc-kr”?>
<?xml:stylesheet type=“text/xs1” href=“f1”?>
<!——group member introduction>
<member>

<member1>

<name>Hong kildong</name>
<university>University</university>

</member1>
<member2>

<name>Kim sooni</name>
<highschool>High school</highschool>

</member2>
<member3>

<name>Kim chulsoo</name>
<middleschool>Middle school</middleschool>

</member3>

</member>

Document file f2

<?xml version=“1.0” encoding=“euc-kr”?>
<?xml:stylesheet type=“text/xs1” href=“fl”?>
<!——member introduction>
<member>

<member1>

<name>Hong kildong</name>
<university>University</university>

</member1>
<member2>

<name>Kim sookhee</name>
<highschool>High school</highschool>

</member2>
<member3>

<name>Kim chulsoo</name>
<middleschool>Middle school</middleschool>

</member3>

</member>

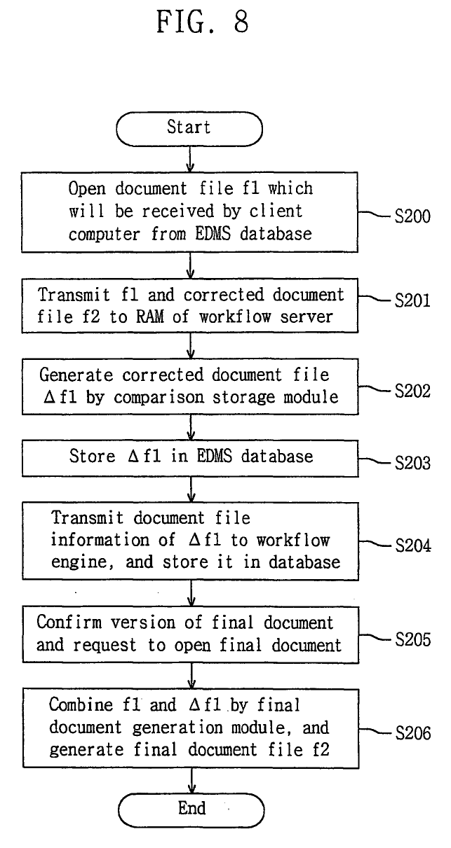

FIG. 8 is a flowchart showing a process for correcting and storing the document file and generating the final document file by using XML in the workflow system in accordance with the present invention.

In order for the user to correct the document file f1, a browser XML interpreter and editor (not shown) for interpreting and editing the XML must be mounted on the client computer 10.

To correct document file f1, the user opens the document file f1 from the EDMS database 33 by using the workflow engine 21 and the adapter module 23, and displays the document file f1 on the screen of the client computer 10 by using the XML interpreter and editor (S200). Here, the document file f1 is temporarily stored in the RAM of the client computer 10.

When the user corrects “Kim sooni” into “Kim sookhee” by employing the XML interpreter and gives a storage command, the original document file f1 is stored in the EDMS database 33 as it is, and the XML interpreter transmits the document file f1 and the document file f2 to the RAM of the workflow engine 21 (S201).

The comparison storage module 22 of the workflow engine 21 compares the document file f1 with the corrected document file f2, searches the corrected part of the document, and generates a corrected document file Δf1 with the corrections according to the XML tag pair (S202).

Thereafter, identical to the general document file addition process, the flow control module of workflow engine 21 transmits a file addition command to the file management module, and stores the corrected document file Δf1 in the EDMS database 33 through the adapter module 23 and the file management module of the EDMS (S203). The EDMS server 30 transmits information on the document file after the correction, namely whole versions of the document files f1 and f2, the file name, the correction date and the capacity of the corrected document file Δf1 to workflow engine 21, and stores the information in the database 25 (S204).

When the user confirms the version of the final document file in database 25 and requests to open the final document file f2 (S205), the final document generation module 24 confirms the path of the original document file f1 and the corrected document file Δf1 through database 25, transmits an open command to the file management module, and combines the document files f2 and Δf1, thereby providing the final document file to the user (S206). Accordingly, the user can open or correct a desired version of the document file at anytime.

A method for determining the corrected document file Δf1 will now be explained.

The corrected document file is composed of reference tags and a document part included between the reference tags. Here, the “reference tags” imply tags that are not duplicated in the document and are most adjacent to the corrected part of the document. The reference tags exist in pairs.

In principle, with a pair of tags most adjacent to the corrected document part the document contents between the tags are generated as the corrected document file. However, when the most adjacent tags exist in any other parts of the document, the final document file cannot be generated by combining the corrected document file and the original document file. Accordingly, when the tags most adjacent to the corrected part of the document exist in any other parts of the document, the second most adjacent tags are set up as the reference tags of the corrected document file.

As shown in document files f1 and f2 using XML, when “<name>Kim sookhee</name>” including the corrected document part “Kim sookhee” and the most adjacent tags are determined as the corrected document file, if the corrected document file and the original document file f1 are intended to be combined to generate document file f2, the tag pair <name> and </name> exist in any other parts of the document file f1. It is thus impossible to determine which part of document file f1 is to be replaced by the corrected document file.

As a result, the tag pair <name> and </name> cannot be the reference tags. A process for searching the second adjacent tag pair is repeated, judging whether the tags identical to the searched tag pair exist in document f1, and searching the next adjacent tag pair when the tags identical to the searched tag pair exist in document f1. In the case where identical tags are not found, the document contents between the tag pair are determined as the corrected document file Δf1. In this embodiment, the tags that are most adjacent to “Kim sookhee” and not existing in any other parts of the document, are namely the reference tags <member2> and </member2>. The corrected document file Δf1 is generated according to the reference tags.

Corrected Document File Δf1

<member2>

<name>Kim sookhee</name>
<highschool>High school</highschool>

</member2>

Preferably, a program module having an algorithm for determining the corrected document file is included in the comparison storage module.

When the user intends to confirm the version of the final document file in database 25 and opens the final document file f2, the final document generation module 24 confirms the path of the original document file f1 and the corrected document file through database 25, transmits an open command to the file management module, and combines the document files f2 and Δf1, thereby displaying the final document file to the user. In this embodiment, the part of the document file f1 between the tag pair <member2> and </member2> is replaced by the corrected document file Δf1, thereby generating the final document file f2.

Presuming that a final document file f3 is obtained by correcting the document file f2 and that a corrected document file M exists additionally, the document file f2 is initially generated as explained above. Then, document file f2 and the corrected document file Δf2 are combined to generate the final document file f3.

As the present invention may be embodied in several forms without departing from the spirit or essential characteristics thereof it should also be understood that the above-described embodiment is not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

As discussed earlier, in accordance with the present invention, the variation history of the document file can be efficiently: managed in the workflow system through efficient interface between the workflow system and the EDMS system, thereby systematically managing the versions of a document.

Moreover, the markup language such as the XML is used in storing the document file, to minimize the stored data of the document file. Thus, expenses for the document management can be considerably reduced.

In addition, the existing EDMS system can interface with the workflow system without modifications.

What is claimed is:

1. A workflow system for managing versions of a document, which is connected through a communication network to at least one client computer and an electronic document management system (EDMS) server including a database for storing document files for managing versions of the document, and a file management module having functions for managing the files, which includes a workflow engine, a database, and an adapter module for the interface between the workflow engine and the EDMS server, wherein the workflow engine comprises:
a flow control module for generating a control command according to a command from the client computer or self-operation of the workflow engine;
a DB storage module for storing the process definition defined in the client computer, the path of a document file stored in the EDMS server, the version relation between the document files, the correction date and the corrector of the document file in the database; and
a file management module controlled by the flow control module, for calling the function for managing the document file from the EDMS server.

2. The system according to claim 1, wherein the adapter module comprises:
a workflow adapter module for interfacing with the workflow engine; and
an EDMS adapter module for interfacing with the file management module of the EDMS server.

3. The system according to claim 2, wherein the workflow adapter module comprises an addition application program interface (API), correction API, deletion API, login API, logout API and open API, the EMDS adapter comprises at least one adapter implementation module for interfacing with the file management module of the EDMS server according to the specifications of the EDMS system, and each of the APIS calls the adapter implementation module by calls from the file management module of the workflow engine.

4. The system according to claim 1, wherein the EDMS server stores the document file in the EDMS database by using a markup language having a tag pair, and the workflow engine comprises:
a comparison storage module for comparing the before-correction document with the after-correction document, searching the corrected document part, adding the searched document part between the markup language tag pair, and storing the corrected document file in the EDMS database; and
a final document generation module for generating the after-correction document file by combining the before-correction document file and the corrected document file.

5. The system according to claim 4, wherein the corrected document file comprises reference tags including the corrected document part and document contents included between the reference tags, and the reference tags are most adjacent to the corrected part and do not exist in any other parts of the document.

6. The system according to claim 4, wherein the markup language is an extensible markup language (XML).

7. A method for managing the versions of a document in a workflow system, which is connected through a communication network to at least one client computer and an EDMS server including a database for storing document files for managing the versions of the document, and a file management module having functions for managing the files, which includes a workflow engine, a database, and an adapter module including a plurality of application program interfaces (API) for interface between the workflow engine and the EDMS server, and an implementation module for calling the function for managing the files from the EDMS server, comprising:
a step for storing an environment value including information on specifications of the EMDS server;
a step wherein the workflow engine receives a document work command through the client computer, and calls the corresponding API from the adapter module;
a step wherein the called API calls the adapter implementation module of the adapter module corresponding to the environment value; and
a step wherein the adapter implementation module calls the function for performing the user's document work command from the file management module of the EDMS system, and performs the user's command.

8. The method according to claim 7, further comprising a step wherein the EDMS server individually stores the before-correction document file and the after-correction document file, transmits information including a file name, version, correction date and capacity of the after-correction document file to the workflow engine, and stores the information in the database of the workflow engine, when the contents of the document are altered according to the user's command.

9. The method according to claim 7, further comprising:
a step wherein the EDMS server stores the document file in the EDMS database by using a markup language having a tag pair, and the workflow engine compares the before-correction document with the after-correction document, searches the corrected document part, adds the searched document part between the markup language tag pair, and stores the corrected document file in the EDMS database; and
a step for generating the after-correction document file by combining the before-correction document file and the corrected document file.

10. The method according to claim 9, wherein the corrected document file comprises reference tags including the corrected part and the document contents included between the reference tags, and the reference tags are most adjacent to the corrected part and do not exist in any other parts of the document.

11. The method according to claim 9, wherein the markup language is an extensible markup language (XML).
